(19) United States
(12) Patent Application Publication
(10) Pub. No.: US 2012/0131624 A1
(43) Pub. Date: May 24, 2012

(54) Apparatus and Method for Multi-User Construction of Tagged Video Data

(75) Inventors: Greg Garner, Springdale, AR (US); David Westerhoff, Fremont, CA (US); Mark Goodwin, Mountain View, CA (US); Patrick Ellis, San Jose, CA (US); Wendy Abowd, Santa Cruz, CA (US)

(73) Assignee: ROKU, INC., Saratoga, CA (US)

(21) Appl. No.: 12/952,958

(22) Filed: Nov. 23, 2010

(51) Int. Cl. H04N 7/173

(52) U.S. Cl. 725/100; 725/131

(57) ABSTRACT

A video content source includes a processor and a download module executed by the processor to download or stream selected videos from a video library. A tag collection module executed by the processor receives tag data from users viewing the selected videos from different set-top boxes. The tag data provides content descriptors from the users for the selected videos. A tag search module executed by the processor searches the tag data from the users in response to a search command from a user.

### FIELD OF THE INVENTION

This invention relates generally to video signal processing. More particularly, this invention relates to the construction of tagged video data by multiple users to provide enhanced capabilities to identify video content of interest.

### BACKGROUND OF THE INVENTION

With the proliferation of video-on-demand, consumers now have access to massive libraries of video content. Traditionally, video service provider's have offered limited search capabilities. Search criteria is typically limited to titles and show descriptions. There is no ability, for example, to find movies with “classic cars” or clothes by a specific designer. Providing additional search criteria is a challenge in view of the volume of content and possible criteria.

Accordingly, it would be desirable to provide improved techniques for documenting and searching video content.

### SUMMARY OF THE INVENTION

A set-top box provides the ability to receive video content from a remote source and display it on a television screen or monitor. A receiver receives video content. An audio/video processor processes the video content. A processor executes tag collection instructions that prompt a user to enter tag data characterizing the video content.

A video content source is typically an array of processing units and databases, but in its simplest form includes a processor and a download module executed by the processor to download or stream selected videos from a video library. A tag collection module executed by the processor receives tag data from users viewing the selected videos from different set-top boxes. The tag data provides content descriptors from the users for the selected videos. A tag search module executed by the processor searches the tag data from the users in response to a search command from a user.

The invention allows users to characterize videos and individual scenes with tag data. Over time, the tag data grows to provide users with an enormous range of search options and criteria. The invention leverages participation from many users to benefit the community of users. This is a form of “crowd sourcing” where tasks traditionally performed by an employee or contractor are “outsourced” to a large group of people (a crowd).

### BRIEF DESCRIPTION OF THE FIGURES

The invention is more fully appreciated in connection with the following detailed description taken in conjunction with the accompanying drawings, in which:

FIG. 1 illustrates a system configured in accordance with an embodiment of the invention.

FIG. 2 illustrates a set top box configured in accordance with an embodiment of the invention.

FIG. 3 illustrates tag collection processing performed in accordance with an embodiment of the invention.

FIG. 4 illustrates a tag template utilized in accordance with an embodiment of the invention.

FIG. 5 illustrates archived tag data configured in accordance with an embodiment of the invention.

FIG. 6 illustrates video search processing operations performed in accordance with an embodiment of the invention.

FIG. 7 re-indexed archived tag data utilized in accordance with an embodiment of the invention.

Like reference numerals refer to corresponding parts throughout the several views of the drawings.

### DETAILED DESCRIPTION OF THE INVENTION

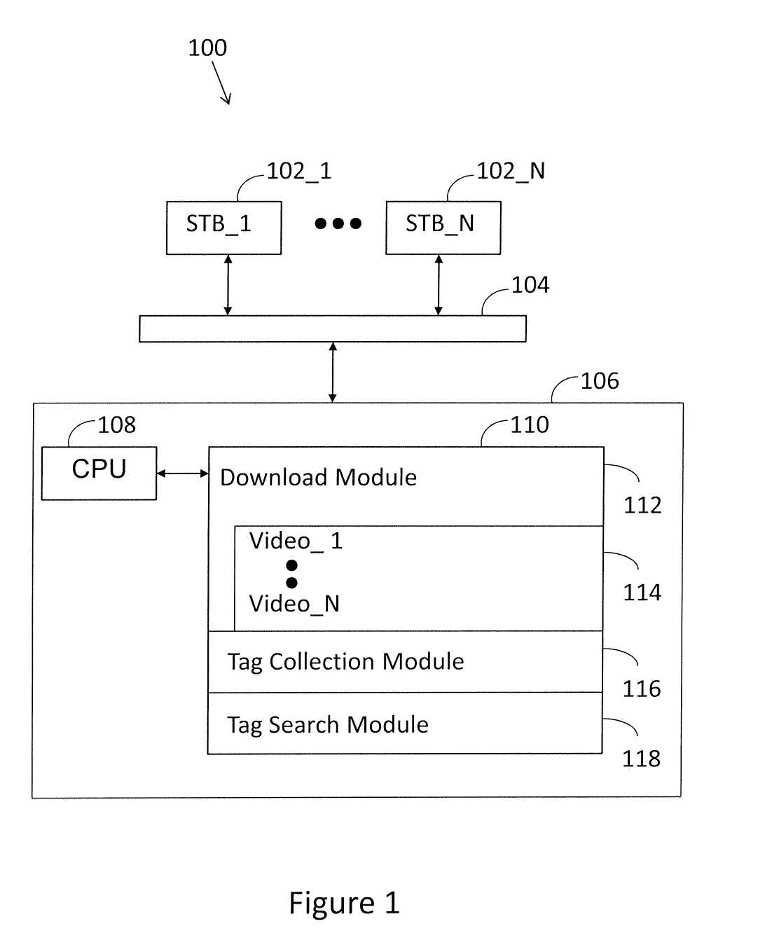

FIG. 1 illustrates a system 100 configured in accordance with an embodiment of the invention. The system 100 includes a set of set-top boxes 102_1 through 102_N. As known in the art, a set-top box is a device that connects to a display (e.g., a television) and an external signal (e.g., a cable signal or a wireless signal). The set-top box processes the external signal and presents its content on the display.

FIG. 1 also illustrates a communication channel 104, which may be any wired or wireless communication channel. For example, the communication channel 104 may be a cable system or the internet.

A video content processor 106 is also connected to the communication channel 104. The video content processor 106 is typically an array of processing units and databases, but in a simplified form includes standard electronic components, such as a central processing unit 108 and a memory 110 storing executable instructions to implement operations of the invention. A download module 112 is executed by the processor 108 to selectively download or stream requested videos (e.g., Video_1 through Video_N) from a video library 114.

The memory 110 also includes a tag collection module 116. The tag collection module 116 includes executable instructions executed by the processor 108 to receive tag data from a set of users viewing selected videos on the set-top boxes (102_1 through 102_N). The tag data is supplied by the users to provide content descriptors for the selected videos. For example, if a user is watching “To Catch a Thief”, the user may “tag” Grace Kelly's car scene with “Grace Kelly”, “Classic Car” and/or “Sunbeam-Talbot Alpine Sports MK I Roadster”. A tag may be associated with an individual scene and/or the entire video. A tag may be associated with a time coded segment of video (e.g., content offset 1 hour and 3 minutes from the start).

The memory 110 also includes a tag search module 118. The tag search module 118 includes executable instructions executed by the processor 108 to search the tag data from all of the users in response to a search command from one of the users, as further discussed below.

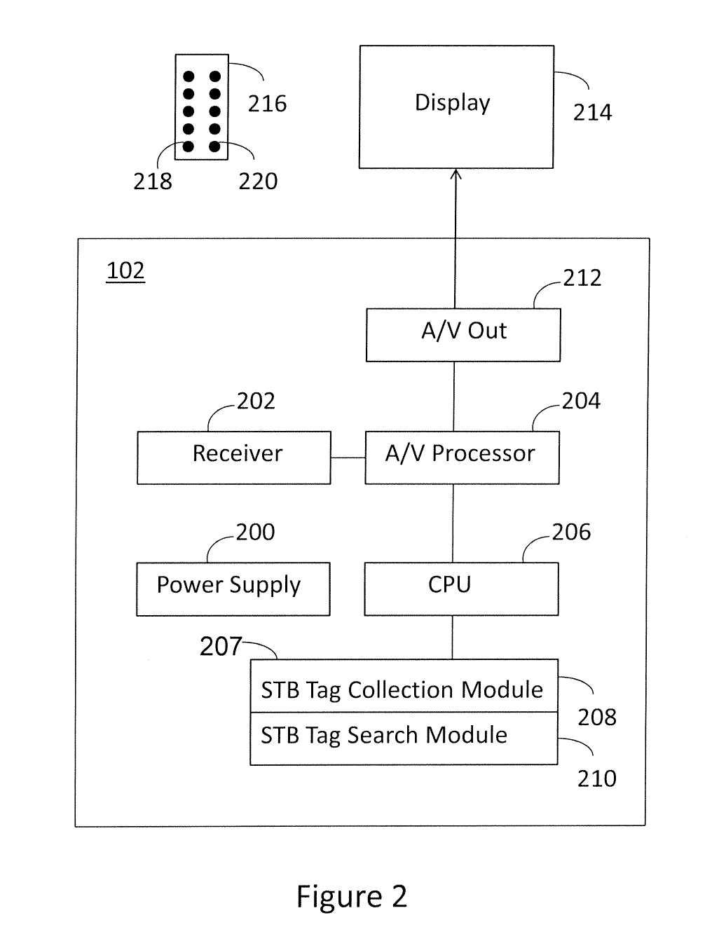

FIG. 2 illustrates a set-top box 102 configured in accordance with an embodiment of the invention. The set-top box 102 includes standard components, such as a power supply 200 and a video receiver 202, which may be configured for wired and/or wireless video signal reception. An audio/video processor 204 processes signals received by the receiver 202 and generates corresponding video content that is applied to audio/video output ports 212 for presentation on a display 214. The audio/video processor 204 operates in conjunction with a central processing unit 206, which accesses memory 207. Memory 207 stores executable instructions to implement operations of the invention. In one embodiment, the memory 207 stores a set-top box (STB) tag collection module 208 and an STB tag search module 210, the operations of which are discussed below.

The set-top box 102 is operative in connection with a remote control 216. In one embodiment, the remote control 216 includes a button 218 to initiate a tag collection operation and a button 220 to initiate a tag search operation. Alternately, pull-down menus associated with the display may be used to invoke these operations.

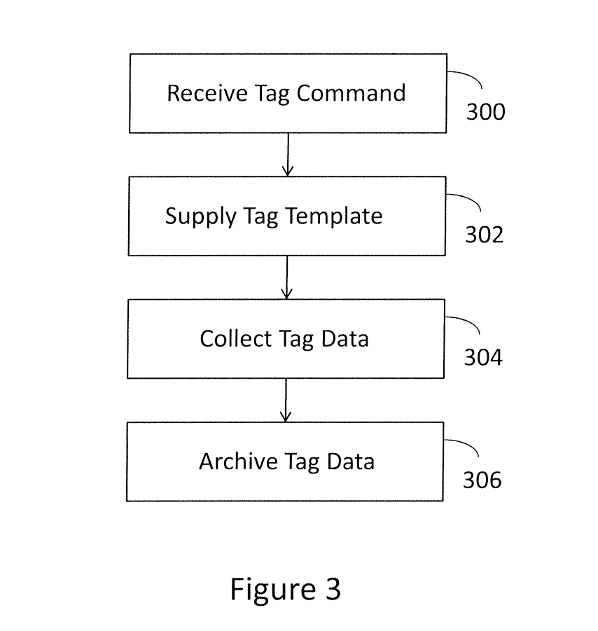

FIG. 3 illustrates processing operations associated with a set-top box 102 configured in accordance with an embodiment of the invention. In particular, FIG. 3 illustrates processing operations associated with an embodiment of the tag collection module 208. Initially, a tag command is received 300. The tag command may be received from a remote control 216 associated with the set-top box 102. The tag command may be generated through a dedicated key 218 or through a menu driven process controlled by the remote control 216.

In response to the tag command, a tag template is supplied 302. The tag template is then used to collect tag data 304.

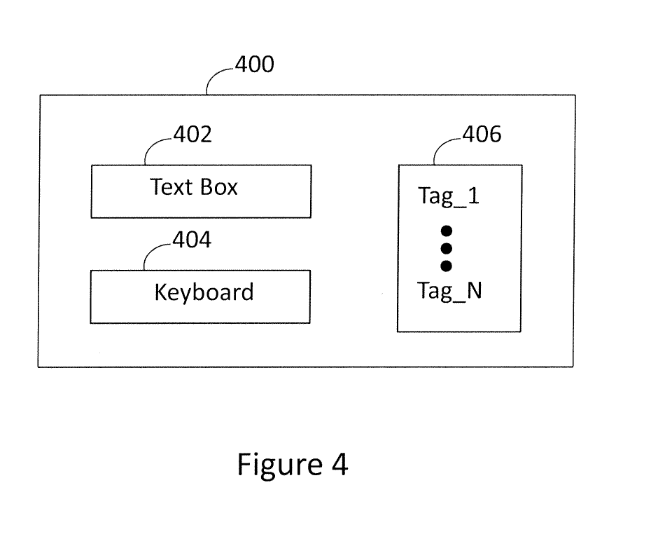

FIG. 4 provides an example of a tag template 400. In this embodiment, the tag template 400 includes a text box 402 to enter a custom description of the video content. The custom description may be formed using a keyboard 404 controlled by remote 216. The displayed video is typically paused while the user provides tag data.

Alternately, selectable tags 406 may be used to characterize the content. The selectable tags are designated using the remote 216. In this case, a pre-existing lexicon is invoked to characterize the content and thereby provides some normalization of the characterizations supplied by disparate users.

Other approaches to generating tagged content may also be used. For example, the tag command may be received by the set-top box 102 and then be passed to the tag collection module 116 of the video content processor 106. The tag collection module 116 may then email the user a tag template that includes a show title, scene index and a screen shot. The email may also include an embedded link, which when activated prompts the user for tag data.

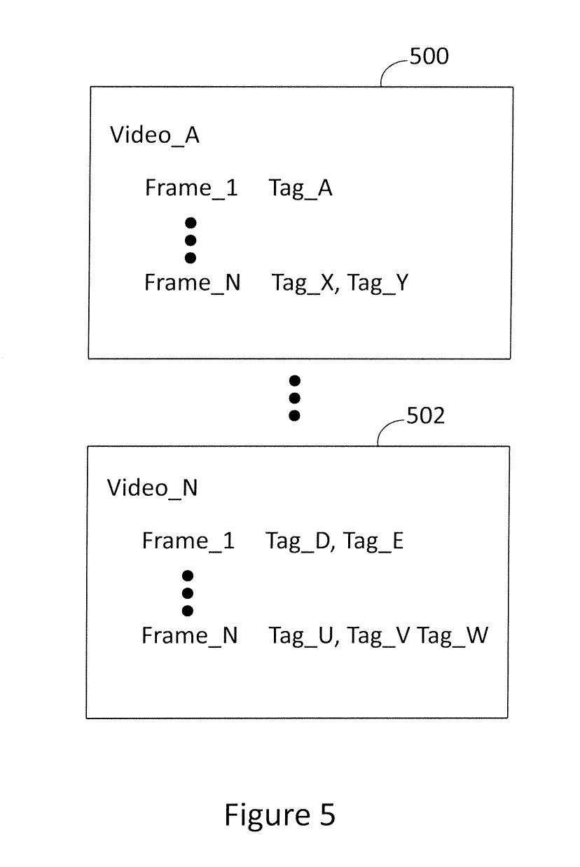

Returning to FIG. 3, the tag data is then archived 306 by uploading it to the content server 106. FIG. 5 illustrates an example of a tag archive that may be used in accordance with an embodiment of the invention. In this example, a first video (Video_A) has a first tag (Tag_A) associated with a first frame (Frame_1) and a set of tags (Tag_X, Tag_Y) associated with another frame (Frame_N). Alternately or in addition, the descriptors (tags) may be generally associated with the video.

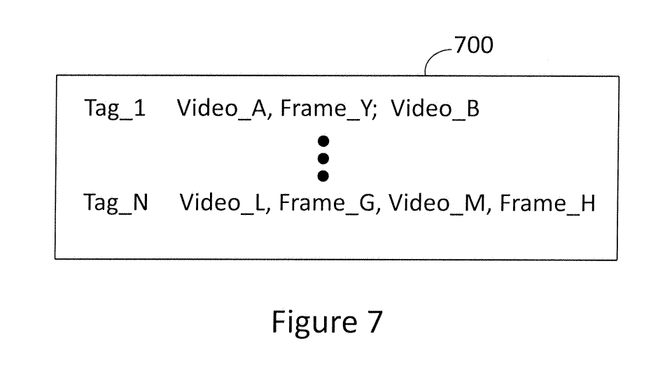

FIG. 5 illustrates another matching of frames and tags for another video (Video_N). The system contemplates large crowds working together to provide tag data for a large corpus of video content. The archived data or sub-sets of it may be stored locally in the set-top box 102. However, the tag collection module 208 also includes executable instructions to upload the tag data to the video content processor 106. The tag collection module 116 of the video content processor 106 receives and organizes the tag data. The tag collection module 116 preferably includes executable instructions to re-index the tag data for optimized search. For example, the tag data of FIG. 5 may be re-indexed to the form illustrated in FIG. 7. FIG. 7 illustrates a format in which individual tags have associated videos. For example, Tag_1 is associated with Video_A, Frame_Y and Video_B. The first associated video points to a specific frame, while the second associated video is generally referenced without a link to a specific frame.

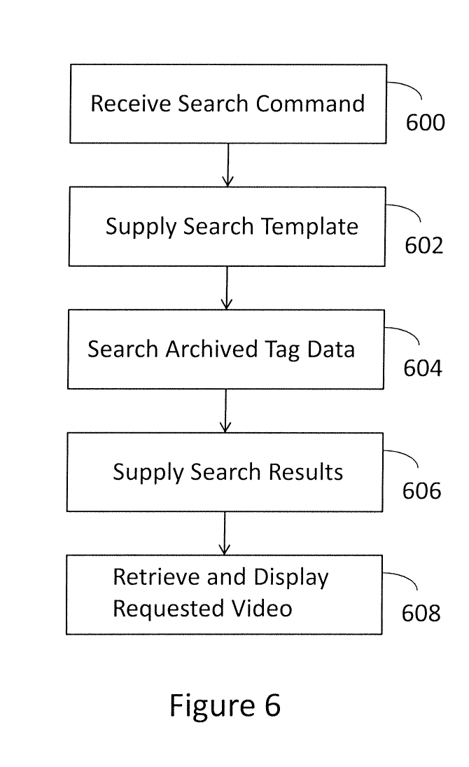

FIG. 6 illustrates operations associated with a tag search module 210 of set-top box 102. Initially, a search command is received 600. The search command may be initiated by a dedicated key 220 of the remote 220. Alternately, the search command may be initiated by selecting an option from a pop-up menu. A search template is then supplied 602. The search template may have the same form as the tag template 400 of FIG. 4. Archived tag data is then searched 604 based upon specified search criteria. A sub-set of the tag data may be cached at the set-top box 102 to support search operations. However, typically the search criteria is routed by the tag search module 118 of the video content processor 106. The tag search module 118 then executes the search and returns search results to the set-top box 102. The set-top box 102 then supplies the search results 606 to the display 214. The search results include individually selectable videos. In addition, the search results may include information, such as where to purchase the video. A requested video may then be retrieved and displayed 608.

Thus, the invention provides a technique for leveraging the work of many individuals to provide a tagging scheme for large volumes of video content. The technique allows an individual to easily retrieve favorite video content by invoking tags previously placed by the individual. In addition, the technique allows an individual to discover content tagged by other individuals participating in the system.

An embodiment of the present invention relates to a computer storage product with a computer readable storage medium having computer code thereon for performing various computer-implemented operations. The media and computer code may be those specially designed and constructed for the purposes of the present invention, or they may be of the kind well known and available to those having skill in the computer software arts. Examples of computer-readable media include, but are not limited to: magnetic media such as hard disks, floppy disks, and magnetic tape; optical media such as CD-ROMs, DVDs and holographic devices; magneto-optical media; and hardware devices that are specially configured to store and execute program code, such as application-specific integrated circuits (“ASICs”), programmable logic devices (“PLDs”) and ROM and RAM devices. Examples of computer code include machine code, such as produced by a compiler, and files containing higher-level code that are executed by a computer using an interpreter. For example, an embodiment of the invention may be implemented using JAVA®, C++, or other object-oriented programming language and development tools. Another embodiment of the invention may be implemented in hardwired circuitry in place of, or in combination with, machine-executable software instructions.

The foregoing description, for purposes of explanation, used specific nomenclature to provide a thorough understanding of the invention. However, it will be apparent to one skilled in the art that specific details are not required in order to practice the invention. Thus, the foregoing descriptions of specific embodiments of the invention are presented for purposes of illustration and description. They are not intended to be exhaustive or to limit the invention to the precise forms disclosed; obviously, many modifications and variations are possible in view of the above teachings. The embodiments were chosen and described in order to best explain the principles of the invention and its practical applications, they thereby enable others skilled in the art to best utilize the invention and various embodiments with various modifications as are suited to the particular use contemplated. It is intended that the following claims and their equivalents define the scope of the invention.

1. A set-top box, comprising:
a receiver to receive video content;
an audio/video processor to process the video content; and
a processor executing tag collection instructions that prompt a user to enter tag data characterizing the video content.

2. The set-top box of claim 1 wherein the processor invokes the tag collection instructions in response to a tag collection signal received from a remote control associated with the set-top box.

3. The set-top box of claim 2 wherein the tag collection instructions include instructions to supply a tag template.

4. The set-top box of claim 3 wherein the tag template includes a text box for entering a custom description of the video content.

5. The set-top box of claim 3 wherein the tag template includes a list of selectable tags for the video content.

6. The set-top box of claim 1 wherein the tag collection instructions include instructions to convey the tag data to a video content source.

7. The set-top box of claim 1 further comprising tag search instructions executed by the processor.

8. The set-top box of claim 7 wherein the processor invokes the tag search instructions in response to a tag search signal received from a remote control associated with the set-top box.

9. The set-top box of claim 8 wherein the tag search instructions include instructions to supply a tag search template.

10. The set-top box of claim 8 wherein the tag search instructions include instructions to search tag data from a plurality of users.

11. The set-top box of claim 10 wherein the tag search instructions are applied to a video content source that searches the tag data from the plurality of users.

12. The set-top box of claim 11 wherein the tag search instructions include instructions to supply search results.

13. The set-top box of claim 12 wherein the tag search instructions include instructions to retrieve and display a requested video.

14. A video content source, comprising:
a processor; and
a download module executed by the processor to download or stream selected videos from a video library;
a tag collection module executed by the processor to receive tag data from a plurality of users viewing the selected videos from a plurality of set-top boxes, wherein the tag data provides content descriptors from the plurality of users for the selected videos;
a tag search module executed by the processor to search the tag data from the plurality of users in response to a search command from one user of the plurality of users.

15. The video content source of claim 14 wherein the tag collection module collects the tag data in a first format and re-indexes the tag data in a second format optimized for search.

16. The video content source of claim 14 wherein the tag search module supplies search results to a set-top box of the one user.

17. The video content source of claim 16 wherein the tag search module supplies a requested video.

18. The video content source of claim 16 wherein the tag search module supplies a specified frame of a requested video, wherein the specified frame is associated with the tag data.

19. The video content source of claim 16 wherein the tag search module supplies a time coded segment of requested video, wherein the time coded segment of requested video is associated with the tag data.
